(19) United States
(12) Patent Application Publication
(10) Pub. No.: US 2022/0207389 A1
(43) Pub. Date: Jun. 30, 2022

(54) ESTIMATION RELIABILITY OF HAZARD WARNING FROM A SENSOR

(71) Applicant: HERE Global B.V., Eindhoven (NL)

(72) Inventors: Advait Raut, Chicago, IL (US); Leon Stenneth, Chicago, IL (US)

(21) Appl. No.: 17/135,705

(22) Filed: Dec. 28, 2020

(51) Int. Cl. G06N 5/04; G08G 1/0967; G06N 20/00; G06N 5/02; G06F 16/245

(52) U.S. Cl. CPC G06N 5/04; G08G 1/0967; G06F 16/245; G06N 5/02; G06N 20/00

(57) ABSTRACT

Systems and methods for a model for estimation of reliability of a hazard sensor observation at a vehicle are disclosed. An example apparatus may include a hazard observation interface configured to receive one or more hazard observations from the hazard sensor of the vehicle, wherein each of the one or more hazard observations is associated with a hazard location and a hazard timestamp, a ground truth module configured to determine ground truth data from one or more weather records from a historical weather database based on the hazard location and the hazard timestamp, and a model configured to perform a comparison of the one or more hazard observations to the one or more weather records, the model trained for estimation of reliability of the hazard sensor observations based on the comparison of the one or more hazard observations to the one or more weather records.

### FIELD

The following disclosure relates to hazard warnings, and more particularly, to the estimation of a reliability of a hazard warning based on a sensor, such as a vehicle sensor.

### BACKGROUND

Driving conditions change very quickly. The path of a storm, fog, or other weather conditions moves across different roadways in a geographic area in different ways and in different coverage areas. These weather conditions can be hazardous to drivers. The weather conditions may be detected by sensors at some vehicles. Warnings may be provided to other vehicles. When warnings can be delivered to drivers, the drivers can prepare for the upcoming conditions. Drivers may choose to slow down, change lanes, exit the road, or stop on the shoulder. Safety is improved, and accidents are avoided.

Warnings are delivered to drivers via connected navigation systems and can be displayed on the head unit screen, cluster screen or a heads-up display. Weather conditions change quickly in time and can vary geographical between locations that are close to each other. Generally, a geographically accurate technique for the detection of weather conditions are vehicle sensors. However, these sensors may fail or produce inaccurate results.

### SUMMARY

In one embodiment, a method for generating a model for estimation of reliability of hazard sensors associated with vehicles includes receiving one or more hazard observations collected from at least one hazard sensor a vehicle, wherein each of the one or more hazard observations is associated with a hazard location and a hazard timestamp, accessing one or more weather records from a historical weather database based on the hazard location and the hazard timestamp, performing a comparison of the one or more hazard observations to the one or more weather records, and training a model for estimation of reliability of the hazard sensor based on the comparison of the one or more hazard observations to the one or more weather records.

In one embodiment an apparatus for generating a model for estimation of reliability of a hazard sensor at a vehicle includes a hazard observation interface, a ground truth module and a model. The hazard observation interface is configured to receive one or more hazard observations from the hazard sensor of the vehicle. Each of the one or more hazard observations is associated with a hazard location and a hazard timestamp. The ground truth module is configured to determine ground truth data from one or more weather records from a historical weather database based on the hazard location and the hazard timestamp. The model is configured to perform a comparison of the one or more hazard observations to the one or more weather records, the model trained for estimation of reliability of the hazard sensor based on the comparison of the one or more hazard observations to the one or more weather records.

In one embodiment, a method for determining reliability of a hazard sensor at a vehicle includes receiving a hazard observation collected at a vehicle in association with a location and a timestamp, accessing a plurality of weather records from a historical weather database based on the location and the hazard timestamp, wherein the plurality of weather records correspond to different map tiles in an area surrounding the location of the hazard observation, and querying a model for an estimation of reliability of the hazard sensor based on the plurality of weather records and the timestamp for the hazard observation.

### BRIEF DESCRIPTIONS OF THE DRAWINGS

Exemplary embodiments of the present invention are described herein with reference to the following drawings.

FIG. 1 illustrates an example system for the estimation of reliability of a hazard warning from a sensor.

FIG. 2 illustrates an example hazard controller for the system of FIG. 1.

FIG. 3 illustrates an example graph for a model for the estimation of reliability of a hazard warning from a sensor.

FIG. 4 illustrates an example server for the system of FIG. 1.

FIG. 5 illustrates an example flow chart for the server of FIG. 4.

FIG. 6 illustrates an example mobile device for the system of FIG. 1.

FIG. 7 illustrates an example flow chart for the mobile device of FIG. 6.

FIG. 8 illustrates exemplary vehicles for the system of FIG. 1.

### DETAILED DESCRIPTION

Driving hazards, or driving conditions, which may be indicative of hazard events, may be communicated to drivers or automated driving systems based on data observations collected locally, or even by other vehicles nearby. The observations may be collected by pedestrians or other mobile devices in other scenarios. The driving conditions may be communicated using a displayed or audible warning of an area affected. The driving conditions may be presented as a geometric shape on a geographic map that illustrates the affected area. In this regard, the data observations collected may be derived from one or more sources, such as sensor data generated by a sensor associated with a vehicle and/or sensor data generated by a sensor separate from the vehicle (e.g., a mobile device traveling in the vehicle or outside of the vehicle). While traveling in the affected area, the warning indicative of the hazard event may be repeated. The user may view the map to recognize the driving condition and adjust operation of the vehicle according. The driver may choose to drive more slowly, pay closer attention, activate one or more system to accommodate the condition, stop driving, change lanes, change roadways, or another response. An automated driving system may response to the driving condition with similar responses.

Example driving conditions may include rain, fog, precipitation, snow conditions, ice conditions, or other weather events. Visibility may also be considered a driving condition or a result of one or more of the driving conditions. Vehicle observations of these weather events, even when sparse, may reliably detect the region that is affected by the hazards. As one example, a vehicle may sense its own wiper blade status (e.g., whether the wiper blades are activated) and/or its own fog lights status (e.g., whether the fog lights are activated) in order to determine rain, precipitation, snow conditions, ice conditions, or other weather events. As another example, the vehicle may detect the status of other vehicles in order to detect a weather event. Specifically, to detect precipitation, vehicle observations of wiper blade status signals may be sufficient to detect the coverage area of precipitation. Further, to detect fog, vehicle observations of fog lights (e.g., rear fog lights) may be sufficient to detect the coverage area of the fog. The term “pseudo sensor” may be used when sensor data or a weather condition is implied from a status signal or other data. When the vehicle senses, either directly by sensors or implied by other status signals, adverse weather conditions, such as rain or fog, the vehicle may send a message to a receiver system along with a sensor status message.

However, there can be chances of the sent message being a false alert or inaccurate signal. Generation of such false alerts can be traced back to several causes. There could be a technical limitation of sensing conditions by the sensor. That is, the sensor may have malfunctions or simply reported a false positive. The sensor cannot always be accurate. When the condition is determined based on a status signal or other data that is not a true sensor, the relationship between may not be accurate. For example, the user may turn on the windshield wiper at times when there is no rain. For example, to clean the windshield. In addition, there may be a problem with sensor status gathering process.

The following embodiments solve the problem of inaccurate sensor data for weather conditions by considering information from other sources along with information gathered from sensor. Using the other sources of data, the sensor data may be filtered and reliable information selected from the sensor data. In one example, a learned model is used to estimate the reliability of the sensor data. The ground truth for the learned model may be derived from past weather information from weather catalog as another source of weather information. The weather information provided by weather catalog can be old or the updating can be delayed or updating period can be large.

The following embodiments also relate to several technological fields including but not limited to navigation, autonomous driving, assisted driving, traffic applications, and other location-based systems. The following embodiments achieve advantages in each of these technologies because improved data for driving or navigation improves the accuracy of each of these technologies. In each of the technologies of navigation, autonomous driving, assisted driving, traffic applications, and other location-based systems, the number of users that can be adequately served is increased. In addition, users of navigation, autonomous driving, assisted driving, traffic applications, and other location-based systems are more willing to adopt these systems given the technological advances in accuracy and speed.

When weather conditions are accurately detected, or at least the reliability of detected weather conditions is determined, autonomous driving systems make corrections. For example, a longer distance may be provided for braking or slower speeds may be used. These corrections improve the safety of the automated driving systems. In addition to the technological improvement of safer autonomous driving systems, navigation systems, in general, may be improved. The preferred route (e.g., fastest route) between an origin and destination may depend on weather conditions. For example, a longer route may be faster when visibility would force very slow speeds on a shorter route. Thus, the technology of route calculations may be improved by the informed reliability of weather conditions.

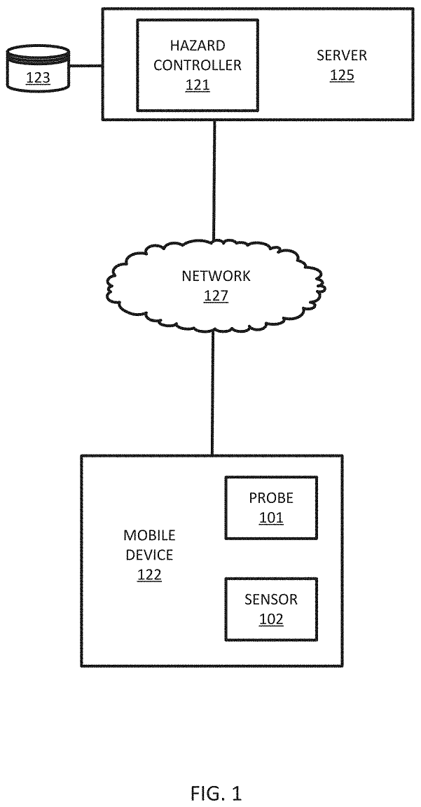

FIG. 1 illustrates an example system for the estimation of reliability of a hazard warning from a sensor. The system may include a mobile device 122, a server 125, and a network 127. The server 125 may include, among other components, a hazard controller 121. Additional, different, or fewer components may be included in the system. The following embodiments may be entirely or substantially performed at the server 125, or the following embodiments may be entirely or substantially performed at the mobile device 122. In some examples, some aspects are performed at the mobile device 122 and other aspects are performed at the server 125.

The mobile device 122 may include a probe 101 or position circuitry such as one or more processors or circuits for generating probe data. The probe points are based on sequences of sensor measurements of the probe devices collected in the geographic region. The probe data may be generated by receiving signals from a global navigation satellite system (GNSS) and comparing the GNSS signals to a clock to determine the absolute or relative position of the mobile device 122. The probe data may be generated by receiving radio signals or wireless signals (e.g., cellular signals, the family of protocols known as WiFi or IEEE 802.11, the family of protocols known as Bluetooth, or another protocol) and comparing the signals to a pre-stored pattern of signals (e.g., radio map). The mobile device 122 may act as the probe 101 for determining the position or the mobile device 122 and the probe 101 may be separate devices.

The probe data may include a geographic location such as a longitude value and a latitude value. In addition, the probe data may include a height or altitude. The probe data may be collected over time and include timestamps. In some examples, the probe data is collected at a predetermined time interval (e.g., every second, every 100 milliseconds, or another interval). In this case, there are additional fields like speed and heading based on the movement (i.e., the probe reports location information when the probe 101 moves a threshold distance). The predetermined time interval for generating the probe data may be specified by an application or by the user. The interval for providing the probe data from the mobile device 122 to the server 125 may be the same or different than the interval for collecting the probe data. The interval may be specified by an application or by the user.

The mobile device 122 may include a sensor 102. There are three may types of sensors that may be used. A first type of sensor directly detects weather conditions. The sensor data 102 may be collected by vehicle sensors that detect the ambient environment of the vehicle 124. For example, a rain sensor may be mounted on the exterior of vehicle 124 to detect rain or other precipitation. The rain sensor may be an optical sensor or a capacitive sensor. The rain sensor may detect drops or particles of precipitation that fall on a plate or a chamber. In another example, data collected by a temperature sensor may be used in combination with the data collected by the rain sensor to infer the type of precipitation (e.g., rain, sleet, snow, ice, etc.). The rain sensor may measure the quantity of the precipitation, the rate of the precipitation, or the intensity of the precipitation.

A second type of sensor indirectly detects weather conditions through additional analysis of sensor data from other sensors. For example, the sensor 102 may be a camera that collects images for the vicinity of the vehicle. The weather condition may be determined through analysis of the images. In another example, the sensor 102 may be a light detection and ranging (LiDAR) sensor that generates a point cloud including distance data. Gaps in the point cloud may be indicative of precipitation and/or visibility from the vehicle.

A third type of sensor indicates the status of another device or system from which a weather condition may be implied. The sensor data may be collected by vehicle sensors that detect the operation of one or more systems or features of the vehicle 124. The weather condition may be inferred from the use of a device, system, or operation of the vehicle 124. Precipitation may be inferred from a windshield wiper sensor or wiper blade sensor that detects when the windshield wipers are running, or at a specific speed or interval. Snow conditions may be inferred from operation of an all-wheel drive or four-wheel drive mode. Ice conditions may be inferred from traction control or anti-lock brakes activation. Fog conditions may be inferred from the operation of fog lights such as rear fog lights. In one example, the headlights, or lights in general, may infer the existence of a reduced visibility event. When the headlights are used, the time of day may limit the associated. For example, the system may detect a limited visibility event when it is daylight (e.g., the current time is between an expect dawn and dusk for the detected geographic location) and the headlights are turned on by the driver of the vehicle, or automatically.

Communication between the mobile device 122 and the server 125 through the network 127 may use a variety of types of wireless networks. Some of the wireless networks may include radio frequency communication. Example wireless networks include cellular networks, the family of protocols known as WiFi or IEEE 802.11, the family of protocols known as Bluetooth, or another protocol. The cellular technologies may be analog advanced mobile phone system (AMPS), the global system for mobile communication (GSM), third generation partnership project (3GPP), code division multiple access (CDMA), personal handy-phone system (PHS), and 4G or long term evolution (LTE) standards, 5G, DSRC (dedicated short range communication), or another protocol.

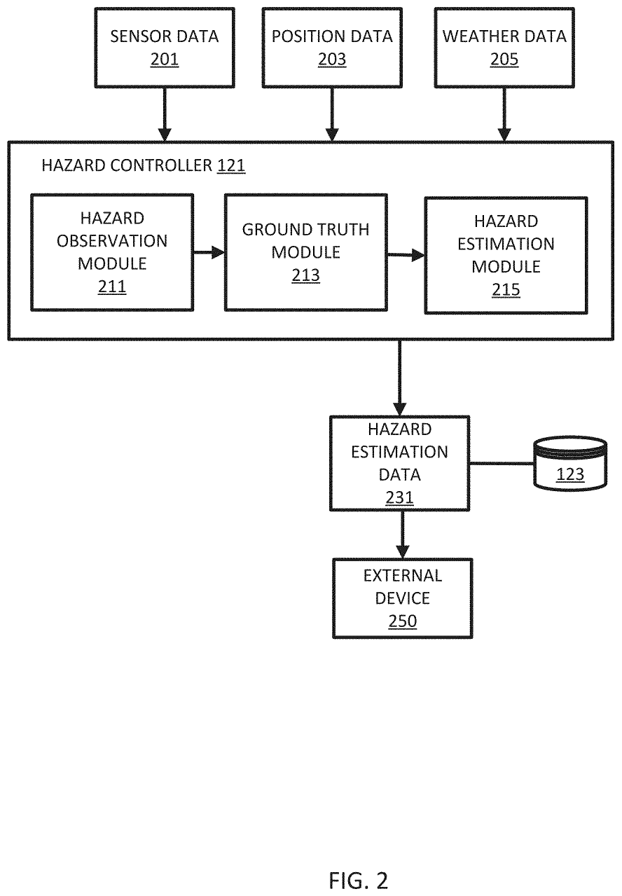

FIG. 2 illustrates an example hazard controller 121 for the system of FIG. 1. While FIG. 1 illustrates the hazard controller 121 at server 125, the mobile device 122 may also implement the hazard controller 121. Additional, different, or fewer components may be included.

The hazard controller 121 may include a hazard observation module 211, a ground truth module 213, and hazard estimation module 215. Other computer architecture arrangements for the hazard controller 121 may be used. The hazard controller 121 receives data from one or more sources. The data sources may include sensor data 201, position data 203, and/or weather data 205. The term sensor data 201 refers to data collected at the vehicle related to ambient conditions. The position data 203 refers to the detected position of the vehicle, which in some examples may be based, at least in part, on certain aspects of the sensor 201. The weather data 205 may be received from an external source (e.g., historical weather logs or weather station reports). Additional data sources are discussed in other embodiments.

The sensor data 201 may be aggregated from multiple mobile devices. The sensor data 201 may be aggregated across a particular service, platform, and application. For example, multiple mobile devices may be in communication with a platform server associated with a particular entity. For example, a vehicle manufacturer may collect video from various vehicles and aggregate the videos. In another example, a map provider may collect sensor data 201 using an application (e.g., navigation application, mapping application running) running on the mobile device 122.

The position data 203 may include any type of position information and may be determined by the mobile device 122 and stored by the mobile device 122 in response to collection of the sensor data 201. The position data 203 may include geographic coordinates and at least one angle that describes the viewing angle for the associated image data. The at least one angle may be calculated or derived from the position information and/or the relative size of objects in the image as compared to other images.

The position data 203 and the sensor data 201 may be combined in geocoded images. A geocoded image has embedded or otherwise associated therewith one or more geographic coordinates or alphanumeric codes (e.g., position data 203) that associates the image (e.g., sensor data 201) with the location where the image was collected. The mobile device 122 may be configured to generate geocoded images using the position data 203 collected by the probe 101 and the sensor data 201 collected by the camera or other sensor 102.

The position data 203 and the sensor data 201 may be collected at a particular frequency. Examples for the particular frequency may be 1 sample per second (1 Hz) or greater (more frequent). The sampling frequency for either the position data 203 and the sensor data 201 may be selected based on the sampling frequency available for the other of the position data 203 and the sensor data 201. The hazard controller 121 is configured to downsample (e.g., omit samples or average samples) in order to equalize the sampling frequency of the position data 203 with the sampling frequency of the sensor data 201, or vice versa.

The hazard controller 121 receives the sensor data 201, position data 203, and weather data 205 and trains a model so that subsequent sensor data may be analyzed by the model to determine the reliability of the subsequent sensor data. The hazard observation interface 211 is configured to receive one or more hazard observations from the sensor data 201, position data 203, and weather data 205. The hazard observation interface 211 may include a different communication interface for each type of data. The sensor data 201 may be received through an electrical connection to the sensor 102. The position data 203 may be received from position circuitry. The weather data 205 may be received from a radio.

The hazard observation interface 211 may fuse the sensor data 201 with the position data 203 and/or time data. That is, the hazard observation interface 211 may associate a data value from the sensor data 201 with a corresponding data value from the position data 203 so that the sensor data is connected with the location from which it was collected. In some example, a timestamp for the sensor data 201 is matched with a timestamp for the position data 203. The hazard observation interface 211 may associate the timestamps with the fused data. The hazard observation interface 211 may store associated data such as the sensor data 201, the position data 203 and/or time data in an array. In another example, the hazard observation interface 211 may also append one or more identifiers or markers on the sensor data 201. The identifiers may include an identification value for the vehicle, mobile device, service provider, or manufacturer thereof. The markers may include timestamps, record identifiers, or other values for tracking the data within the hazard controller 121.

The ground truth module 213 is configured to determine ground truth data from one or more weather records from a historical weather database based on the hazard location and the hazard timestamp. The weather data 205 is historical data that describes where a weather condition was occurring before the hazard observation was made at the vehicle. For the ground truth, the historical weather data may be recent weather records. For example, the historical weather data for the group truth may be limited to a time period before the hazard observation was made. The time period, for example, may be 30 minutes.

The hazard estimation module 215 is configured to perform a comparison of the one or more hazard observations to the one or more weather records. The model is trained for estimation of reliability of the hazard sensor based on the comparison of the one or more hazard observations to the one or more weather records. When the recent historical weather data matches the hazard observation (i.e., the recent historical weather data confirms that a weather conditions occurred), the ground truth is positive for that data point. Thus, the ground truth for any hazard observation may be the weather record for the same location occurring within 30 minutes of the observation. Of course, the data set for training may span a much larger time period (e.g., months or years) but for determining ground truth only a set time window of the historical data is used for each observation. At the time of training, both the historical weather data and the observation data used for training may be months to years old.

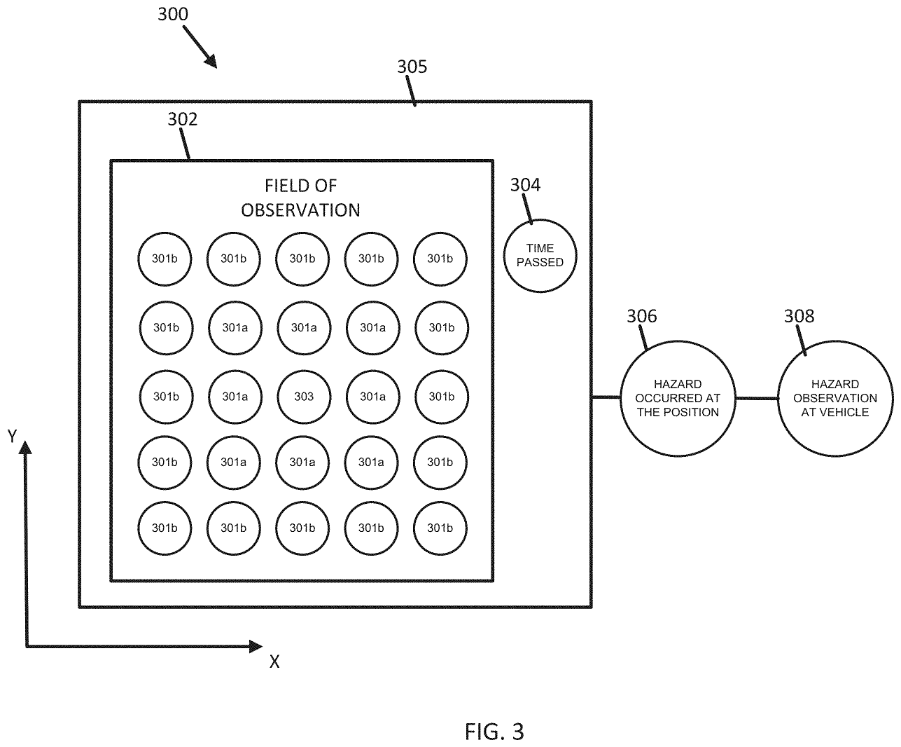

The model is supplied with other variables for training the model against the ground truth. The other variables may include data from a geographic area surrounding the observation. FIG. 3 illustrates an example graph 300 for a model for the estimation of reliability of a hazard warning. The graph 300 may represent a Markov network or Bayesian network. The network may include one or more dependent variables and one or more independent variables. In graph 300, one or more of the network variables may be assigned to a location in a field of observation 302. The field of observation may also be tightly coupled to another variable, such as the time passed 304, as a clique. The graph 300 may be factor according to one or more cliques. Hence, the field of observation 302 and the time passed 304 are shown as linked or dependent in a variable plate 305.

The graph 300 includes a field of observation 302, a variable for time passed 304, a hazard occurred at the position 306, and a hazard occurred at the vehicle 308. The field of observation is an area surrounding the location of the observation. The field of observation may include a fixed dimension (e.g., rectangle or square of few kilometers on any side) divided into several smaller tiles or cells of equal size. The field of observation 302 may include a center cell 303, corresponding to the observation, and multiple neighboring cells 301. The neighboring cells 301 may include a first ring of cells 301a and a second ring of cells 301b. The size of the field of observation 302 may be defined by a number of rings of cells. The cells may be indexed according to a first dimension X from the center cell 303 and a second dimension Y from the center cell so that each cell is indexed as C_{x,y}. The values for X and Y may be positive or negative according to any convention.

The size of the field of observation 302 may be a predetermined size or dimension based defined according to the location from the one or more hazard observation. The size of the field of observation 302 may be determined based on one or more factors. The factors may include the type of geography. Rural areas may have larger fields that urban areas. Areas with roads of a higher functional classification (e.g., highways) may have a larger field than areas with roads of a lower functional classification (e.g., surface streets).

Each cell in the field of observation may be assigned one or more independent variables. A weather condition variable may describe the weather condition of the cell. Example values for the weather condition include intensity of the precipitation, whether it is raining, a visibility distance, and/or whether there is reduced visibility.

These variables may have binary values or Boolean values. For example, whether it is raining is either a yes or no or true or false. These variables may have a scaled value (e.g., between 0 or 1). For example, the intensity of the precipitation may be divided by a maximum precipitation intensity in order to determine the scaled value. The variables may have absolute values.

The variable time passed 304 may describe the amount of time between the hazard observation and the historical weather data associated with the hazard observation. As described above, the time passed may have a maximum value limited by the time window. The time passed 304 is the amount of time for the last weather reported by the weather system for the location of the hazard observation. The time passed value may be minutes to hours, depending on the time window selected.

The variable for hazard occurred at the position 306 represents if hazardous condition actually occurred during the targeted time window and targeted location corresponding to the hazard observation. The variable for hazard occurred at the position 306 may be a hidden or latent variable. It represents the ground truth situation at the target location and targeted instance of time. The variable for hazard occurred at the position 306 may be a value between 0 and 1.

The value for vehicle sensor observation, represented by cell 303, is a Boolean variable representing if vehicle has sent adverse weather condition flag. It is an observed variable. It has constant value in this case which is TRUE. Instances where the value for vehicle sensor observation is not true may not be used for training the model.

The variable for a hazard occurred at the position 308 is a latent variable. It represents the ground truth situation at the target location and targeted instance of time. Variables from field of observation group and the variable time passed representing past weather situations of all cells are linked with hazard occurred at the position 308 variable.

When the model or graph 300 described above is a Markov network, including variables for the field of observation and time passed are tightly coupled to each other as a clique or variable plate. An example function of this Markov network is described in

$$P ( Haz\_Cond \_Occ \vert X , TimePassed , w ) = \frac{1}{Z ( X , Time\_Passe d , w ; VehSenObs = 1 )} exp ( - E ( Haz\_Cond \_Occ , X , TimePassed , w ; VehSenOb = 1 ) ) \qquad Equation 1$$

Z is partition function. E is an energy function. The dependent variable w may be an array including a set of model parameters. For example, different model parameters may be used for models such as a random forest, a support vector machine, a deep neural network, or others. The variable for time passed 304 is Time_Passed. The variable for hazard occurred at the position 306 is Haz_Cond_Occ. The variable for hazard occurred at the vehicle 308 is VehSenOb. P (Haz_Cond_Occ|X,TimePassed,w) gives the probability of ground truth hazard condition.

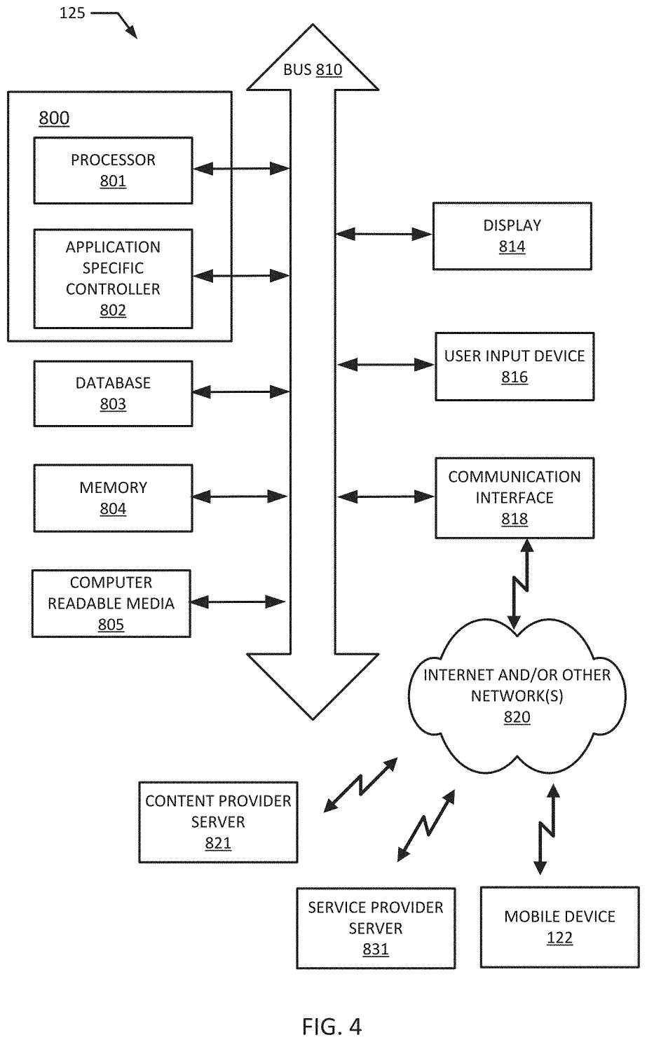

FIG. 4 illustrates an example server 125 for the system of FIG. 1. The server 125 may include a bus 810 that facilitates communication between a controller (e.g., the hazard controller 121) that may be implemented by a processor 801 and/or an application specific controller 802, which may be referred to individually or collectively as controller 800, and one or more other components including a database 803, a memory 804, a computer readable medium 805, a display 814, a user input device 816, and a communication interface 818 connected to the internet and/or other networks 820. The contents of database 803 are described with respect to database 123. The server-side database 803 may be a master database that provides data in portions to the database 903 of the mobile device 122. Additional, different, or fewer components may be included.

The memory 804 and/or the computer readable medium 805 may include a set of instructions that can be executed to cause the server 125 to perform any one or more of the methods or computer-based functions disclosed herein. In a networked deployment, the system of FIG. 4 may alternatively operate or as a client user computer in a client-server user network environment, or as a peer computer system in a peer-to-peer (or distributed) network environment. It can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. While a single computer system is illustrated, the term “system” shall also be taken to include any collection of systems or sub-systems that individually or jointly execute a set, or multiple sets, of instructions to perform one or more computer functions.

The server 125 may be in communication through the network 820 with a content provider server 821 and/or a service provider server 831. The server 125 may provide the point cloud to the content provider server 821 and/or the service provider server 831. The content provider may include device manufacturers that provide location-based services associated with different locations POIs that users may access.

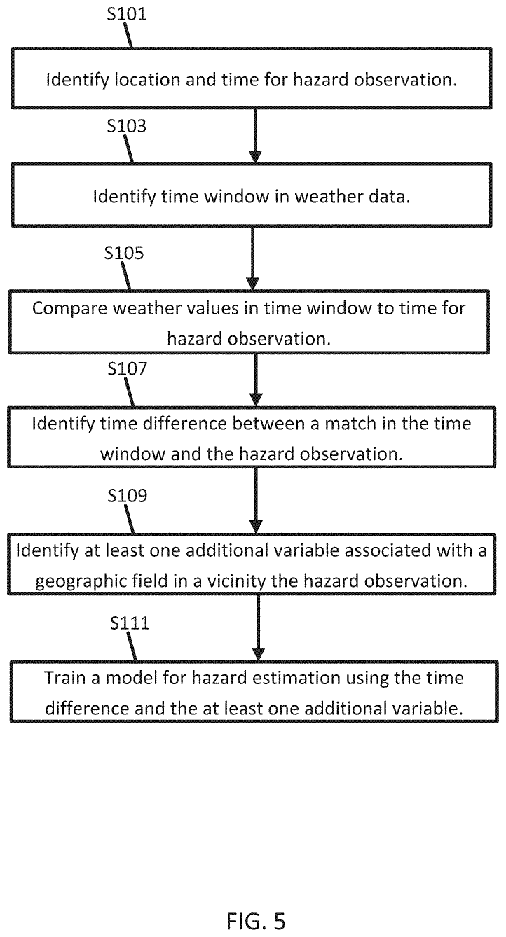

FIG. 5 illustrates an example flow chart for generating a model for estimation of reliability of hazard sensors associated with vehicles. While the flow chart is discussed with respect to the server 125 some or all of the acts described in the flow chart may also be performed by the mobile device 122. Additional, different, or fewer acts may be included.

At act S101, the controller 800 identifies location and time for a hazard observation. The hazard observation may be received over the communication interface 818 and network 820 from the vehicle or mobile device 122 including sensor 102 for collecting the hazard observation. The hazard observation is associated with a hazard location and a hazard timestamp.

In one embodiment, multiple hazard observations may be received and used to train the model. The multiple hazard observations may be collected from the same vehicle over time. The multiple hazard observations may be collected from different vehicles. For example, vehicles in the same cell or different cells of the field of observation 302.

At act S103, the controller 800 identifies a time window in the weather data in order to retrieve the latest available past weather at the hazard location, which is stored in memory 80. The weather data may be received from a weather station. For example, the weather station may include a service provider server 831 that transmits weather data upon request or at time intervals.

The time window may be a predetermined amount of time. The amount of time is set so that the historical weather record is close enough to the observation to be considered ground truth. The amount of time may be set by a user or administrator, for example, through user input device 816. The amount of time may be any value such as 15 minutes, 30 minutes, or an hour. The weather data may be considered the true weather data even though inaccuracies may still occur.

At act S105, the controller 800 compares weather values from the historical weather record in the time window to time for hazard observation. When the values match a positive observation is identified and when the values do not match a negative observation is identified. A match can be with the weather condition is the same in both the historical record and the hazard observation (e.g., both indicate raining, both indicate fog, both indicate low visibility, etc.). A match may occur when both historical record and the hazard observation indicate some sort of weather condition (e.g., raining in the observation is still considered a match to low visibility in the historical record).

Acts S107 and S109 involve identification and application of the variables for training the model against the ground truth. At act S107, the controller 800 identifies a time difference between a match in the time window and the hazard observation.

At act S109, the controller 800 identifies at least one additional variable associated with a geographic field in a vicinity of the hazard observation. The at least one additional variable may be a weather condition some to all of the cells in the field of observations 302. The weather condition for each of the cells that include a weather condition or a matching weather condition.

Table 1 indicates an example set of variable data for training the model.

| | WEATHER IS | | TIMEDIFF | | | | | | | |
|---|---|---|---|---|---|---|---|---|---|---|
| | RAINING @ | | (VEHICLE SENSOR | | | | | | | |
| VEHICLE | VEHICLE CELL | | OBS, LATEST | | RAIN @ | RAIN @ | RAIN @ | RAIN @ | RAIN @ | |
| SENSOR | WINTHIN | | AVAILABLE | | VEHICLE | NEAR BY | NEAR BY | NEAR BY | NEAR BY | |
| OBS | 30 MIN GAP | LABEL | CATALOG TIME) | | CELL | CELL 1 | CELL 2 | CELL 3 | CELL 4 | [symbol] |
| 1 | 1 | 1 | 34 | min | 1 | 0 | 0 | 0 | 1 | [symbol] |
| 1 | 1 | 1 | 5 | min | 0 | 0 | 0 | 0 | 0 | [symbol] |
| 1 | 0 | 0 | 31 | min | 0 | 1 | 1 | 1 | 1 | [symbol] |
| 1 | 0 | 0 | 2 | min | 0 | 1 | 1 | 0 | 0 | [symbol] |
| [symbol] | | | | | | | | | | |

At act S111, the controller 800 trains a model for hazard estimation using the time difference and at least one additional variable. The model for estimation of reliability of the hazard sensor is based on the comparison of the one or more hazard observations to the one or more weather records. A variety of learned models or learnt models may be used. The model may be a random forest or deep neural network. Other learning models such as decision trees, logistic regression naive bayes may be used.

Multiple neural networks may be used. One of the neural networks may be trained according to data collected in rural areas. One of the neural networks may be trained according to data collected in suburban areas. One of the neural networks may be trained according to data collected in urban areas. The location data may be compared to geographic areas that are associate with rural, suburban, or urban areas in order to route the collected data for the training of specific neural networks. Multiple neural networks may be used according to the location data for topographical features. One of the neural networks may be trained according to data collected in mountainous areas. One of the neural networks may be trained according to data collected in forest or high vegetation areas. One of the neural networks may be trained according to data collected in desert or low vegetation areas. The location data may be compared to geographic areas that are associate with mountains, forests, or deserts areas in order to route the collected data for the training of specific neural networks. Different neural networks may be used according to the location data or one or more attributes from the geographic database 123. The attributes may be road attributes related to the shape, curvature, slope, functional classification, speed limit or other aspects of the road segments. One of the neural networks may be trained according to data collected on roads with a first attribute. One of the neural networks may be trained according to data collected on roads with a second attribute. Different neural networks may be used according to the type of vehicle or vehicle sensors. Example types of vehicle include bus, car, truck and others. The type of vehicle may be encoded in the sensor data collected by the vehicle.

Once trained, the model may be supplied with later collected data in order to calculate the reliability of subsequent hazard detections, which may be provided to other devices such as mobile device 122 or display 814. The reliability of a hazard detection may be a predicted value or probability that a hazard has actually occurred at the position of the observation. Thus, the system of estimation of the reliability of hazard observation may receive a subsequent hazard observation and a subsequent weather observation. The system queries the model for estimation of reliability of the hazard sensor based on the subsequent hazard observation and the weather observation.

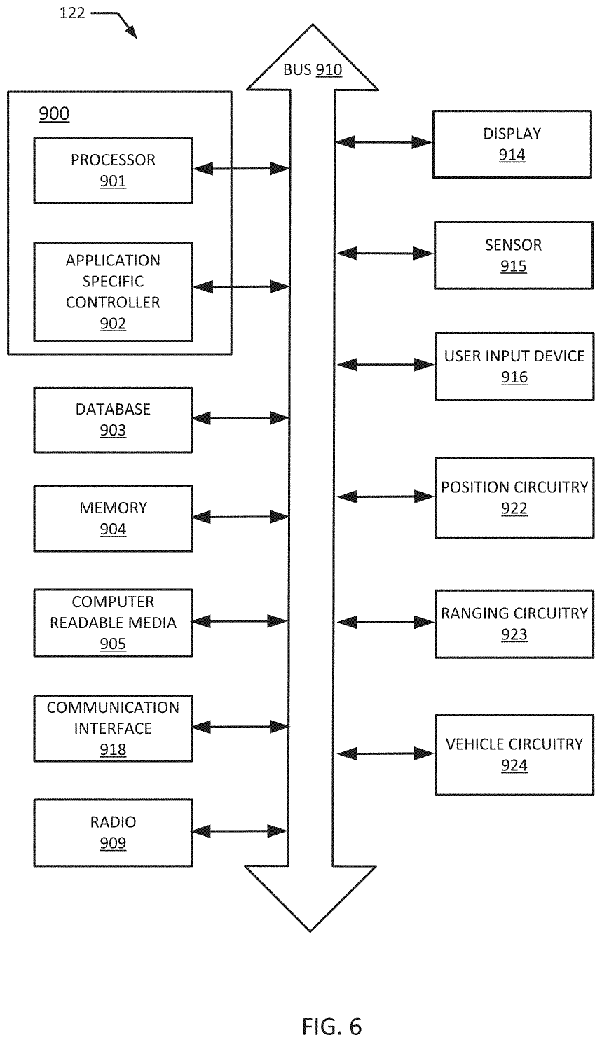

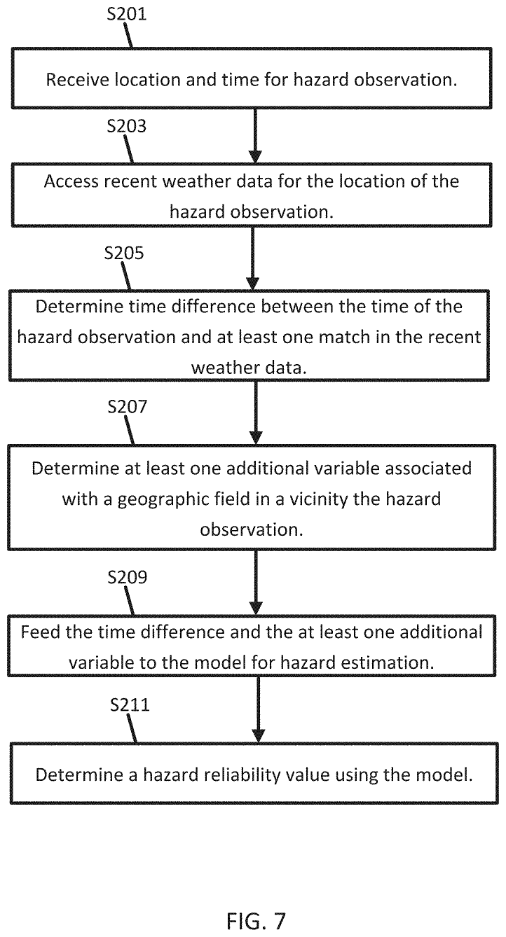

FIG. 7 illustrates an example mobile device 122 for the system of FIG. 1. The mobile device 122 may include a bus 910 that facilitates communication between a controller (e.g., the hazard controller 121) that may be implemented by a processor 901 and/or an application specific controller 902, which may be referred to individually or collectively as controller 900, and one or more other components including a database 903, a memory 904, a computer readable medium 905, a communication interface 918, a radio 909, a display 914, a sensor 915 (e.g., any of the weather related sensors described herein), a user input device 916, position circuitry 922, ranging circuitry 923, and vehicle circuitry 924. The contents of the database 903 are described with respect to database 123. The device-side database 903 may be a user database that receives data in portions from the database 903 of the mobile device 122. The communication interface 918 connected to the internet and/or other networks (e.g., network 820 shown in FIG. 6). The vehicle circuitry 924 may include any of the circuitry and/or devices described with respect to FIG. 9. Additional, different, or fewer components may be included.

FIG. 7 illustrates an example flow chart for the mobile device of FIG. 6. As illustration, the flow chart of FIG. 7 describes the use of the model trained in the flow chart of FIG. 5. Additional, different, or fewer acts may be included.

At act S201, the controller 900 receives location and time for a hazard observation either via communication interface 918 or radio 909 or directly via sensor 915. The collection of the location and hazard observation may be made in real time. That is the information is collected analyzed using the model and an output provided in substantially real time. The hazard observation may include an intensity of precipitation, a precipitation indicator, a visibility distance, and a visibility indicator.

At act S203, the controller 900 accesses recent weather data for the location of the hazard observation. The weather data may be accessed from database 903 or memory 904. The weather data may be received from an external device such as a service.

At act S205, the controller 900 determines time difference between the time of the hazard observation and at least one match in the recent weather data. The time difference may be the time passed since the weather event occurs in the cell of the vehicle observation. The time difference may be the time passed since a weather event in a particular cell in the vicinity of the vehicle observation or in any cell in the vicinity of the vehicle observation. The controller 900 may calculate a time gap between the hazard timestamp of the weather record timestamp.

At act S207, the controller 900 determines at least one additional variable associated with a geographic field in a vicinity the hazard observation. In one example, the additional variable is the weather record for the geographic field. The weather data may be assigned to geographic cells in the vicinity of the hazard observation. A weather data array associated with cell identifiers may be stored in database 903 or memory 904. The weather data for these cells may be indicative of the accuracy of the vehicle observation off the weather condition.

At act S209, the controller 900 feeds the time difference and the at least one additional variable to the model for hazard estimation. The controller 900 executes the model. At act S211, the controller 900 determines a hazard reliability value using the model. The hazard reliability may be a value between 0 and 1 or a probability that the accuracy of the hazard observation is correct. The hazard reliability value may be provided at display 914. For example, the controller 900 may compare the hazard reliability value to a threshold value (e.g., 80% or 90%). When the hazard reliability value exceeds the threshold, the controller 900 may present the location of the hazard observation on the display 914 (e.g., on a map) or may provide an alert for the hazard observation (e.g., rain up ahead). When the hazard reliability value is less than the threshold, the controller 900 may provide a message on the display 914 that indicates that weather information is not available or not reliable.

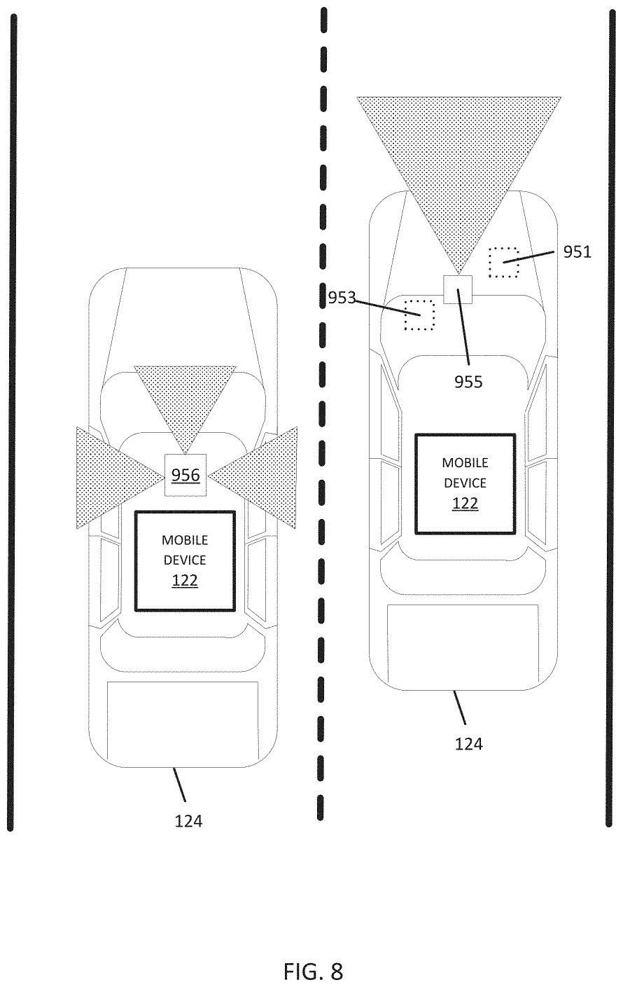

FIG. 8 illustrates an exemplary vehicle 124 associated with the system of FIG. 1 for providing location-based services or applications using the hazard reliability value for the vehicle observations of weather conditions or other hazards. The vehicles 124 may include a variety of devices that collect position data as well as other related sensor data for the surroundings of the vehicle 124. The position data may be generated by a global positioning system, a dead reckoning-type system, cellular location system, or combinations of these or other systems, which may be referred to as position circuitry or a position detector. The positioning circuitry may include suitable sensing devices that measure the traveling distance, speed, direction, and so on, of the vehicle 124. The positioning system may also include a receiver and correlation chip to obtain a GPS or GNSS signal. Alternatively or additionally, the one or more detectors or sensors may include an accelerometer built or embedded into or within the interior of the vehicle 124. The vehicle 124 may include one or more distance data detection device or sensor, such as a LIDAR device. The distance data detection sensor may generate point cloud data. The distance data detection sensor may include a laser range finder that rotates a mirror directing a laser to the surroundings or vicinity of the collection vehicle on a roadway or another collection device on any type of pathway. The distance data detection device may generate the trajectory data. Other types of pathways may be substituted for the roadway in any embodiment described herein.

A connected vehicle includes a communication device and an environment sensor array for reporting the surroundings of the vehicle 124 to the server 125. The connected vehicle may include an integrated communication device coupled with an in-dash navigation system. The connected vehicle may include an ad-hoc communication device such as a mobile device 122 or smartphone in communication with a vehicle system. The communication device connects the vehicle to a network including at least one other vehicle and at least one server. The network may be the Internet or connected to the internet.

The sensor array may include one or more sensors configured to detect surroundings of the vehicle 124. The sensor array may include multiple sensors. Example sensors include an optical distance system such as LiDAR 956, an image capture system 955 such as a camera, a sound distance system such as sound navigation and ranging (SONAR), a radio distancing system such as radio detection and ranging (RADAR) or another sensor. The camera may be a visible spectrum camera, an infrared camera, an ultraviolet camera, or another camera.

In some alternatives, additional sensors may be included in the vehicle 124. An engine sensor 951 may include a throttle sensor that measures a position of a throttle of the engine or a position of an accelerator pedal, a brake senor that measures a position of a braking mechanism or a brake pedal, or a speed sensor that measures a speed of the engine or a speed of the vehicle wheels. Another additional example, vehicle sensor 953, may include a steering wheel angle sensor, a speedometer sensor, or a tachometer sensor.

A mobile device 122 may be integrated in the vehicle 124, which may include assisted driving vehicles such as autonomous vehicles, highly assisted driving (HAD), and advanced driving assistance systems (ADAS). Any of these assisted driving systems may be incorporated into mobile device 122. Alternatively, an assisted driving device may be included in the vehicle 124. The assisted driving device may include memory, a processor, and systems to communicate with the mobile device 122. The assisted driving vehicles may respond to the hazard reliability value and associated hazard observation in combination with driving commands or navigation commands to determine a routing instruction that is at least partially based on the hazard reliability value and associated hazard observation.

The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. Autonomous vehicles may include multiple modes and transition between the modes. The autonomous vehicle may steer, brake, or accelerate the vehicle based on the position of the vehicle in order, and may respond to the hazard reliability value and associated hazard observation.

A highly assisted driving (HAD) vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and the hazard reliability value and associated hazard observation.

Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the hazard reliability value and associated hazard observation.

The controller 900 may communicate with a vehicle ECU which operates one or more driving mechanisms (e.g., accelerator, brakes, steering device). Alternatively, the mobile device 122 may be the vehicle ECU, which operates the one or more driving mechanisms directly.

The controller 800 or 900 may include a routing module including an application specific module or processor that calculates routing between an origin and destination. The routing module is an example means for generating a route in response to the anonymized data to the destination. The routing command may be a driving instruction (e.g., turn left, go straight), which may be presented to a driver or passenger, or sent to an assisted driving system. The display 914 is an example means for displaying the routing command. The mobile device 122 may generate a routing instruction based on the anonymized data.

The routing instructions may be provided by display 914. The mobile device 122 may be configured to execute routing algorithms to determine an optimum route to travel along a road network from an origin location to a destination location in a geographic region. Using input(s) including map matching values from the server 125, a mobile device 122 examines potential routes between the origin location and the destination location to determine the optimum route. The mobile device 122, which may be referred to as a navigation device, may then provide the end user with information about the optimum route in the form of guidance that identifies the maneuvers required to be taken by the end user to travel from the origin to the destination location. Some mobile devices 122 show detailed maps on displays outlining the route, the types of maneuvers to be taken at various locations along the route, locations of certain types of features, and so on. Possible routes may be calculated based on a Dijkstra method, an A-star algorithm or search, and/or other route exploration or calculation algorithms that may be modified to take into consideration assigned cost values of the underlying road segments.

The mobile device 122 may plan a route through a road system or modify a current route through a road system in response to the request for additional observations of the road object. For example, when the mobile device 122 determines that there are two or more alternatives for the optimum route and one of the routes passes the initial observation point, the mobile device 122 selects the alternative that passes the initial observation point. The mobile devices 122 may compare the optimal route to the closest route that passes the initial observation point. In response, the mobile device 122 may modify the optimal route to pass the initial observation point.

The mobile device 122 may be a personal navigation device (“PND”), a portable navigation device, a mobile phone, a personal digital assistant (“PDA”), a watch, a tablet computer, a notebook computer, and/or any other known or later developed mobile device or personal computer. The mobile device 122 may also be an automobile head unit, infotainment system, and/or any other known or later developed automotive navigation system. Non-limiting embodiments of navigation devices may also include relational database service devices, mobile phone devices, car navigation devices, and navigation devices used for air or water travel.

The geographic database 123 may include map data representing a road network or system including road segment data and node data. The road segment data represent roads, and the node data represent the ends or intersections of the roads. The road segment data and the node data indicate the location of the roads and intersections as well as various attributes of the roads and intersections. Other formats than road segments and nodes may be used for the map data. The map data may include structured cartographic data or pedestrian routes. The map data may include map features that describe the attributes of the roads and intersections. The map features may include geometric features, restrictions for traveling the roads or intersections, roadway features, or other characteristics of the map that affects how vehicles 124 or mobile device 122 for through a geographic area. The geometric features may include curvature, slope, or other features. The curvature of a road segment describes a radius of a circle that in part would have the same path as the road segment. The slope of a road segment describes the difference between the starting elevation and ending elevation of the road segment. The slope of the road segment may be described as the rise over the run or as an angle. The geographic database 123 may also include other attributes of or about the roads such as, for example, geographic coordinates, street names, address ranges, speed limits, turn restrictions at intersections, and/or other navigation related attributes (e.g., one or more of the road segments is part of a highway or toll way, the location of stop signs and/or stoplights along the road segments), as well as points of interest (POIs), such as gasoline stations, hotels, restaurants, museums, stadiums, offices, automobile dealerships, auto repair shops, buildings, stores, parks, etc. The databases may also contain one or more node data record(s) which may be associated with attributes (e.g., about the intersections) such as, for example, geographic coordinates, street names, address ranges, speed limits, turn restrictions at intersections, and other navigation related attributes, as well as POIs such as, for example, gasoline stations, hotels, restaurants, museums, stadiums, offices, automobile dealerships, auto repair shops, buildings, stores, parks, etc. The geographic data may additionally or alternatively include other data records such as, for example, POI data records, topographical data records, cartographic data records, routing data, and maneuver data.

The geographic database 123 may contain at least one road segment database record 304 (also referred to as “entity” or “entry”) for each road segment in a particular geographic region. The geographic database 123 may also include a node database record (or “entity” or “entry”) for each node in a particular geographic region. The terms “nodes” and “segments” represent only one terminology for describing these physical geographic features, and other terminology for describing these features is intended to be encompassed within the scope of these concepts. The geographic database 123 may also include location fingerprint data for specific locations in a particular geographic region.

The radio 909 may be configured to radio frequency communication (e.g., generate, transit, and receive radio signals) for any of the wireless networks described herein including cellular networks, the family of protocols known as WiFi or IEEE 802.11, the family of protocols known as Bluetooth, or another protocol.

The memory 804 and/or memory 904 may be a volatile memory or a non-volatile memory. The memory 804 and/or memory 904 may include one or more of a read only memory (ROM), random access memory (RAM), a flash memory, an electronic erasable program read only memory (EEPROM), or other type of memory. The memory 904 may be removable from the mobile device 122, such as a secure digital (SD) memory card.

The communication interface 818 and/or communication interface 918 may include any operable connection. An operable connection may be one in which signals, physical communications, and/or logical communications may be sent and/or received. An operable connection may include a physical interface, an electrical interface, and/or a data interface. The communication interface 818 and/or communication interface 918 provides for wireless and/or wired communications in any now known or later developed format.

The input device 916 may be one or more buttons, keypad, keyboard, mouse, stylus pen, trackball, rocker switch, touch pad, voice recognition circuit, or other device or component for inputting data to the mobile device 122. The input device 916 and display 914 be combined as a touch screen, which may be capacitive or resistive. The display 914 may be a liquid crystal display (LCD) panel, light emitting diode (LED) screen, thin film transistor screen, or another type of display. The output interface of the display 914 may also include audio capabilities, or speakers. In an embodiment, the input device 916 may involve a device having velocity detecting abilities.

The ranging circuitry 923 may include a LIDAR system, a RADAR system, a structured light camera system, SONAR, or any device configured to detect the range or distance to objects from the mobile device 122.

The positioning circuitry 922 may include suitable sensing devices that measure the traveling distance, speed, direction, and so on, of the mobile device 122. The positioning system may also include a receiver and correlation chip to obtain a GPS signal. Alternatively or additionally, the one or more detectors or sensors may include an accelerometer and/or a magnetic sensor built or embedded into or within the interior of the mobile device 122. The accelerometer is operable to detect, recognize, or measure the rate of change of translational and/or rotational movement of the mobile device 122. The magnetic sensor, or a compass, is configured to generate data indicative of a heading of the mobile device 122. Data from the accelerometer and the magnetic sensor may indicate orientation of the mobile device 122. The mobile device 122 receives location data from the positioning system. The location data indicates the location of the mobile device 122.

The positioning circuitry 922 may include a Global Positioning System (GPS), Global Navigation Satellite System (GLONASS), or a cellular or similar position sensor for providing location data. The positioning system may utilize GPS-type technology, a dead reckoning-type system, cellular location, or combinations of these or other systems. The positioning circuitry 922 may include suitable sensing devices that measure the traveling distance, speed, direction, and so on, of the mobile device 122. The positioning system may also include a receiver and correlation chip to obtain a GPS signal. The mobile device 122 receives location data from the positioning system. The location data indicates the location of the mobile device 122.

The position circuitry 922 may also include gyroscopes, accelerometers, magnetometers, or any other device for tracking or determining movement of a mobile device. The gyroscope is operable to detect, recognize, or measure the current orientation, or changes in orientation, of a mobile device. Gyroscope orientation change detection may operate as a measure of yaw, pitch, or roll of the mobile device.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network devices.

Processors suitable for the execution of a computer program include, by way of example, both general and special purpose microprocessors, and anyone or more processors of any kind of digital computer. Generally, a processor receives instructions and data from a read only memory or a random access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry. In an embodiment, a vehicle may be considered a mobile device, or the mobile device may be integrated into a vehicle.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. These examples may be collectively referred to as a non-transitory computer readable medium.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A method for generating a model for estimation of reliability of hazard sensor observations associated with vehicles, the method comprising:
receiving one or more hazard observations collected from at least one hazard sensor a vehicle, wherein each of the one or more hazard observations is associated with a hazard location and a hazard timestamp;
accessing one or more weather records from a historical weather database based on the hazard location and the hazard timestamp;
performing a comparison of the one or more hazard observations to the one or more weather records; and
training a model for estimation of reliability of the hazard sensor observations based on the comparison of the one or more hazard observations to the one or more weather records.

2. The method of claim 1, further comprising:
receiving a subsequent hazard observation;
receiving a weather observation; and
querying the model for estimation of reliability of the hazard sensor based on the subsequent hazard observation and the weather observation.

3. The method of claim 1, further comprising:
defining a field of observation based on the location from the one or more hazard observations.

4. The method of claim 3, wherein the field of observation has a predetermined size or dimension based defined according to the location from the one or more hazard observation.

5. The method of claim 3, wherein the field of observation comprises a plurality of map tiles.

6. The method of claim 5, wherein each of the plurality of map tiles is associated with at least one weather record from the historical weather database.

7. The method of claim 6, wherein the at least one hazard variables includes an intensity of precipitation, a precipitation indicator, a visibility distance, and a visibility indicator.

8. The method of claim 1, wherein the one or more weather records from the historical weather database is associated with a weather record timestamp, the method further comprising:
calculating a time gap between the hazard timestamp of the weather record timestamp, wherein the model for estimation of reliability of the hazard sensor is based on the time gap.

9. An apparatus for generating a model for estimation of reliability of a hazard sensor observations at a vehicle, the apparatus comprising:
a hazard observation interface configured to receive one or more hazard observations from a hazard sensor of the vehicle, wherein each of the one or more hazard observations is associated with a hazard location and a hazard timestamp;
a ground truth module configured to determine ground truth data from one or more weather records from a historical weather database based on the hazard location and the hazard timestamp; and
a model configured to perform a comparison of the one or more hazard observations to the one or more weather records, the model trained for estimation of reliability of the hazard sensor observations based on the comparison of the one or more hazard observations to the one or more weather records.

10. The apparatus of claim 9, wherein the ground truth model is configured to determine the ground truth data based on a field of observation based on the location from the one or more hazard observations.

11. The apparatus of claim 9, wherein the ground truth model is configured to determine the ground truth data based on weather records for a plurality of map tiles.

12. A method for determining reliability of observations from a hazard sensor at a vehicle, the method comprising:
receiving a hazard observation collected at a vehicle in association with a location and a timestamp;
accessing a plurality of weather records from a historical weather database based on the location and the hazard timestamp, wherein the plurality of weather records correspond to different map tiles in an area surrounding the location of the hazard observation; and
querying a model for an estimation of reliability of the hazard sensor based on the plurality of weather records and the timestamp for the hazard observation.

13. The method of claim 12, further comprising:
defining a field of observation for the different map tiles in the area surrounding the location from the hazard observation.

14. The method of claim 13, wherein the field of observation has a predetermined size or dimension based defined according to the location from the hazard observation.

15. The method of claim 14, wherein the field of observation comprises a plurality of map tiles.

16. The method of claim 14, wherein each of the plurality of map tiles is associated with at least one weather record from the historical weather database.

17. The method of claim 16, wherein the at least one hazard variables includes an intensity of precipitation, a precipitation indicator, a visibility distance, and a visibility indicator.

18. The method of claim 12, further comprising:
performing a comparison of the estimation of the reliability of the hazard sensor to a threshold value.

19. The method of claim 18, further comprising:
calculating a routing instruction in response to the comparison.

20. The method of claim 18, further comprising:
displaying an alert in response to the comparison.
